(19) United States
(12) Patent Application Publication
(10) Pub. No.: US 2008/0056192 A1
(43) Pub. Date: Mar. 6, 2008

(54) LATENCY REDUCTION BY ADAPTIVE PACKET FRAGMENTATION

(75) Inventors: Peter N. Strong, Newton Abbot (GB); Timothy G. Wild, Totnes (GB); Gregor R. Dean, Seaton (GB)

Correspondence Address: MOTOROLA, INC., 1303 EAST ALGONQUIN ROAD, IL01/3RD, SCHAUMBURG, IL, 60196, US

(73) Assignee: PIPING HOT NETWORKS LIMITED, Devon (GB)

(21) Appl. No.: 11/469,196

(22) Filed: Aug. 31, 2006

(51) Int. Cl. H04Q 7/00

(52) U.S. Cl. 370/331

(57) ABSTRACT

A wireless broadband communications system and method that achieves reduced latency for high priority data when multiplexed with lower priority data for transmission over a TDD point-to-point radio link. The system prepares multiple data streams for transmission over a TDD radio link by buffering multiple data streams containing high and low priority packets in separate queues based upon their corresponding priority level. Each packet in the higher priority queues has a specified size, and a header defining the type of service provided and the packet destination. Next, the packets in the lower priority queues are fragmented to a reduced size based upon the data capacity of the link. The high priority packets and the fragmented, low priority packets are arranged in a sequence such that the high priority packets are transmitted first, and the low priority packets are transmitted when no data is buffered in any high priority queue.

### CROSS REFERENCE TO RELATED APPLICATIONS

Not applicable

### STATEMENT REGARDING FEDERALLY SPONSORED RESEARCH OR DEVELOPMENT

Not applicable

### BACKGROUND OF THE INVENTION

The present invention relates generally to wireless broadband communications systems, and more specifically to a system and method of multiplexing multiple data streams for transmission over a time division duplex (TDD), adaptively modulated, point-to-point radio link that achieves reduced latency for delay-critical, high priority data.

Wireless broadband communications systems are known that employ adaptive modulation techniques for transmitting data streams over one or more time division duplex (TDD) point-to-point radio links. Such wireless communications systems typically include a transmitter and receiver disposed at one end of a TDD point-to-point radio link, and a transmitter and receiver disposed at the other end of the radio link. Each transmitter may be configured to transmit data streams over one or more communications channels using specified error correction coding and modulation techniques. Further, each receiver may be configured to capture the transmitted data streams, and to employ specified signal processing techniques for decoding and demodulating the signals to recover the user data. Such wireless communications systems typically employ adaptive modulation techniques to adjust transmission parameters such as the coding rate and modulation mode, thereby maximizing the bandwidth of the radio link while maintaining the signal-to-noise ratio at an acceptable level.

In conventional wireless communications systems configured to transmit multiple data streams over TDD point-to-point radio links, each radio link is typically set up between a pair of antennas disposed at respective ends of the link. Further, each radio link typically carries multiple data streams of various types with different levels of priority, e.g., low priority Ethernet data streams, mid-level priority Ethernet data streams, and/or delay-critical, high priority E1/T1 data streams. For example, high priority data streams may contain voice or video traffic, while lower priority data streams may be employed for performing data downloads or backup. Each type of data stream generally has a data structure that includes a number of frames or packets, the size of which typically depends on the type of data service being provided (e.g., high, mid-level, or low priority data). For example, the data structure of an Ethernet data stream typically includes frames or packets having respective headers that define the service type (e.g., mid-level or low priority data) and the packet destination. Ethernet frames typically have a maximum length of 1500 data bytes plus a header, while some proprietary links providing gigabit or faster Ethernet service may employ “jumbo” Ethernet frames having a length of about 9000 bytes. In contrast, an E1/T1 data stream typically has a repeating data structure. For example, an E1/T1 data stream with a 125 μsec frame structure defining a repetition rate of 8 kHz has been designed for carrying multiplexed voice traffic having a sampling rate of 8 kHz. Whereas the type of service being provided and the packet destination are defined within the headers of Ethernet frames, the type of service and packet destination are defined by context in E1/T1 data streams.

Ethernet data streams may be carried over E1/T1 links using an intermediate network layer, or using any other suitable nested data structure in which one type of frame or packet is contained within another type of frame or packet. In nested data structures, in which the lower layers have a smaller maximum frame size than the upper layers, a fragmentation-and-reassembly layer is typically employed for fragmenting incoming Ethernet frames to the smaller frame size before transmission, and for reassembling the frame fragments upon reception to obtain the original data format. When transmitting Ethernet frames over a TDD point-to-point radio link, the size of the Ethernet frames can be adjusted to match or be a fraction of the capacity of the TDD transmission bursts, thereby making the process of assembling the TDD bursts more efficient.

However, the above-described conventional wireless communications systems for transmitting multiple data steams over TDD point-to-point radio links have drawbacks. For example, if factors such as the bandwidth availability and/or atmospheric conditions cause a radio link to become a bottleneck to data transmission, then the multiple data streams may be prioritized within the constraints of the maximum acceptable latency for the data. Such prioritization of data streams can be problematic, however, when high priority data is being provided in a continuous stream for transmission with lower priority data over the same radio link, and the radio link has limited excess capacity above what is needed to transmit the high priority data. In this case, the size of the frames or packets corresponding to low priority data may be too large, and may therefore make it difficult to maintain an acceptable latency level for the high priority data. In such systems, the incoming high and low priority data are typically segmented into frames or packets, which are multiplexed and transmitted sequentially over the radio link. For example, the low priority frames in the transmission sequence may be inserted in timeslots between the high priority packets. However, the size of the lower priority frames may be too large to allow the frames to fit into the timeslots between the high priority packets, without increasing the latency for the high priority data.

Such prioritization of data streams can also be problematic when the high priority data is not provided for transmission in a continuous stream. For example, when the data streams are prioritized for transmission, the high and low priority data are typically buffered in two or more queues based upon the level of priority of the data. Because, in this case, the high priority data is not being provided in a continuous stream, the data in the high priority queues may be transmitted first, followed by the data in the lower priority queues, which may be transmitted when the high priority queues are empty. However, the size of the lower priority frames may be such that while the low priority data is being transmitted, there is sufficient time for high priority data to accumulate in the high priority queues. As a result, the transmission of the high priority data in the queues may be effectively blocked while the large, low priority frames are being transmitted, possibly causing the maximum acceptable latency for the high priority data to be exceeded.

In addition, conventional wireless communications systems can employ adaptive modulation techniques to increase the bandwidth of a TDD point-to-point radio link, within the limitations of the signal-to-noise ratio on the link, by implementing spectrally efficient modulation formats. However, when conditions for wireless signal propagation on the radio link are unfavorable, such techniques may actually cause the bandwidth of the link and/or the data capacity of TDD bursts to decrease, thereby possibly causing the latency for delay-critical, high priority data on the link to increase to unacceptable levels.

It would therefore be desirable to have a wireless broadband communications system and method that can be used to transmit multiple data streams providing different types of data service (e.g., high priority, mid-level priority, or low priority data) over a TDD, adaptively modulated, point-to-point radio link, without increasing the latency for the high priority data to unacceptable levels. Such a wireless communications system would avoid the drawbacks of the above-described conventional systems.

### BRIEF SUMMARY OF THE INVENTION

In accordance with the present invention, a wireless broadband communications system and method is provided that achieves reduced latency for delay-critical, high priority data when such data is multiplexed with lower priority data for transmission over a time division duplex (TDD), adaptively modulated, point-to-point radio link. The presently disclosed wireless communications system buffers multiple incoming streams of high and lower priority data in a plurality of queues, segments the data streams into frames or packets, fragments the frames in the lower priority queues based at least in part upon the current data capacity of the radio link to form a plurality of fragmented packets of reduced size, and transmits the fragmented packets in a multiplexed fashion with the high priority data. The presently disclosed system can be employed to multiplex high priority data streams, e.g., E1/T1 data streams, with lower priority data streams, e.g., Ethernet data streams, for subsequent transmission over the same radio link, without violating the maximum acceptable latency for the high priority data.

In one mode of operation, the presently disclosed wireless communications system prepares multiple data streams including high priority packets and lower priority frames for transmission over a TDD point-to-point radio link by buffering the packets and frames in separate queues based upon their corresponding level of priority. For example, the priority level of the packets and frames may be determined by identifying the physical source of the data, or by examining information contained in one or more packet or frame headers. Each of the packets in the high priority queues has a specified size, and is provided with a header defining the type of data service being provided (e.g., high priority data) and the packet destination. Next, the frames in the lower priority queues are fragmented to form a plurality of fragmented packets having a specified reduced size based upon the current data capacity of the radio link. In one embodiment, the size of the fragmented packets is adjusted to match or be a fraction of the capacity of a TDD transmission burst, thereby making the process of assembling multiple TDD bursts more efficient. Like the high priority packets, each of the fragmented packets is provided with a header defining the type of service being provided (e.g., mid-level or low priority data) and the packet destination. The high priority packets and the fragmented, lower priority packets are then arranged in a sequence such that the high priority packets are transmitted first, and the lower priority packets are transmitted when no data is being buffered in any one of the high priority queues. In one embodiment, the high priority packets and the lower priority packets are arranged in the sequence in an alternating fashion such that the fragmented, lower priority packets are inserted into timeslots between the high priority packets. Next, the sequence including the high priority packets and lower priority packets is transmitted over the radio link. Upon reception of the data packet sequence, the headers included in both the high priority packets and the fragmented, lower priority packets are removed, and the original data streams are reassembled.

By buffering multiple incoming streams of high and lower priority data into separate queues, segmenting the data streams into frames or packets, fragmenting the frames in the lower priority queues to form a plurality of fragmented packets of reduced size based upon the current data capacity of the radio link, and transmitting the high priority packets and the fragmented, lower priority packets in a multiplexed fashion over a TDD, adaptively modulated, point-to-point radio link, multiple data streams having different levels of priority can be transmitted over the same radio link, without violating the maximum acceptable latency for the high priority data.

Other features, functions, and aspects of the invention will be evident from the Detailed Description of the Invention that follows.

### BRIEF DESCRIPTION OF THE SEVERAL VIEWS OF THE DRAWINGS

The invention will be more fully understood with reference to the following Detailed Description of the Invention in conjunction with the drawings of which:

FIG. 1 is a block diagram of a conventional wireless communications system for transmitting multiple data streams over a point-to-point radio link;

FIG. 2a depicts two high priority data streams transmitted by the conventional system of FIG. 1, in which the high priority data is multiplexed onto a radio link with excess capacity;

FIG. 2b depicts two high priority data streams and a single low priority data stream transmitted by the conventional system of FIG. 1, in which the high priority data is multiplexed onto a radio link with the low priority data;

FIG. 3 is a block diagram of a wireless broadband communications system for transmitting multiple streams of high and lower priority data over a TDD point-to-point radio link according to the present invention;

FIG. 4 depicts two high priority data streams and a single low priority data stream transmitted by the system of FIG. 3, in which low priority frames are fragmented to form a plurality of fragmented packets to reduce the latency for the high priority data;

FIG. 5 depicts an illustrative structure of the fragmented packets of FIG. 4; and

FIG. 6 is a flow diagram of a method of operating the system of FIG. 3.

### DETAILED DESCRIPTION OF THE INVENTION

A wireless broadband communications system and method is disclosed that achieves reduced latency for delay-critical, high priority data when such data is multiplexed with lower priority data for transmission over a time division duplex (TDD), adaptively modulated, point-to-point radio link. The presently disclosed wireless communications system can be employed to multiplex high and lower priority data streams for transmission over the same radio link, while maintaining the latency for the high priority data at an acceptable level.

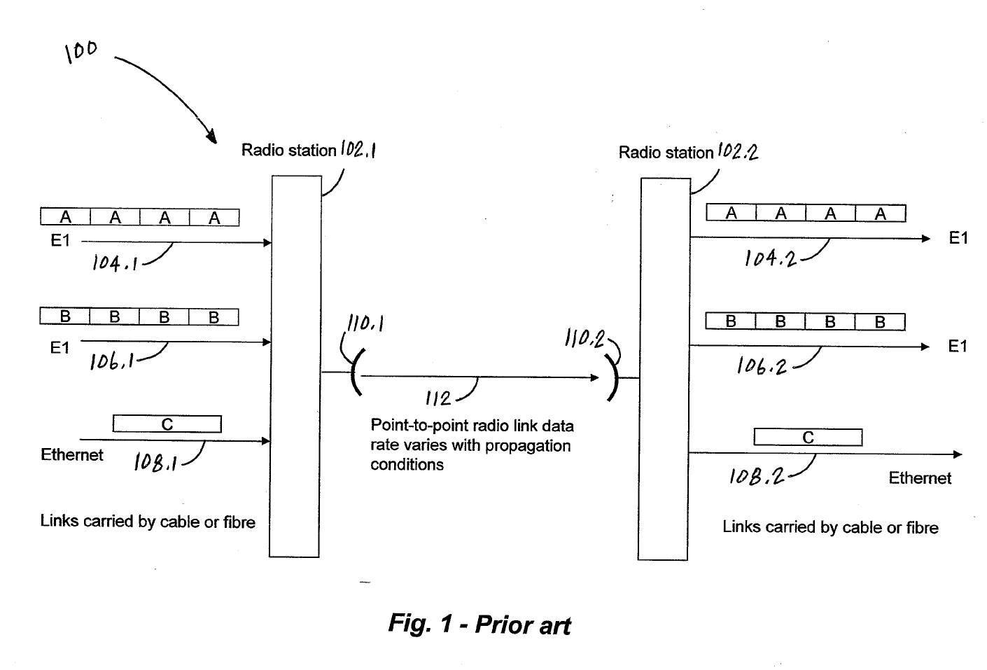

FIG. 1 depicts a conventional wireless communications system 100 configured to transmit multiple data streams over a TDD point-to-point radio link 112. As shown in FIG. 1, the conventional system 100 includes two radio stations 102.1-102.2 and two antennas 110.1-110.2. The radio station 102.1 is coupled to two high priority E1/T1 communications links 104.1, 106.1, and a single low priority Ethernet communications link 108.1. Similarly, the radio station 102.2 is coupled to two high priority E1/T1 communications links 104.2, 106.2, and a single low priority Ethernet communications link 108.2. For example, each of the links 104.1, 106.1, 108.1 may be implemented by a copper or optical fiber cable. The E1/T1 link 104.1 provides a first high priority data stream including a plurality of packets A to the radio station 102.1, and the E1/T1 link 106.1 provides a second high priority data stream including a plurality of packets B to the radio station 102.1. Further, the Ethernet link 108.1 provides a low priority data stream including at least one frame C to the radio station 102.1. The radio station 102.1 is configured to transmit the high and low priority data streams over the radio link 112 via the antenna 110.1, and the radio station 102.2 is configured to receive the transmitted data via the antenna 110.2. It is noted that the rate of data transmission over the radio link 112 can vary with atmospheric conditions, which can adversely affect the propagation of wireless signals over the link. Finally, the radio station 102.2 provides the high priority packets A, B on the E1/T1 links 104.2, 106.2, respectively, and provides the low priority frame on the Ethernet link 108.2.

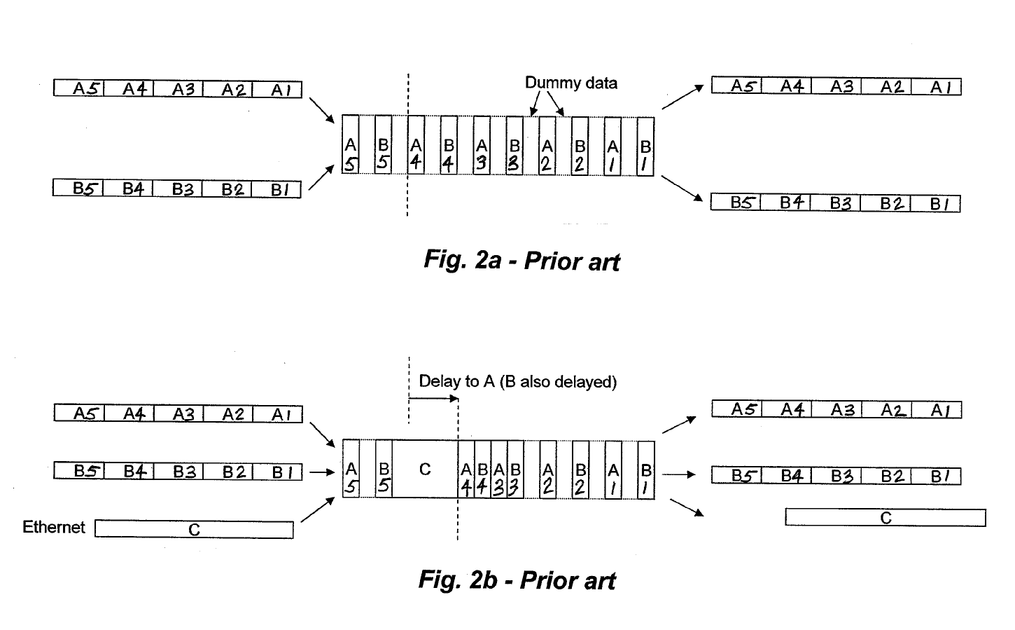

FIG. 2a illustrates two high priority E1/T1 data streams that may be provided via the respective E1/T1 links 104.1, 106.1 for transmission by the radio station 102.1 (see FIG. 1). As shown in FIG. 2a, a first high priority E1/T1 data stream is segmented into a plurality of packets A1-A5, and a second high priority E1/T1 data stream is segmented into a plurality of packets B1-B5. In this illustrative example, it is assumed that each of the high priority data streams is continuous, and that the size of each of the packets A1-A5, B1-B5 is adjusted to match or be a fraction of the capacity of a TDD burst, thereby making the process of assembling the TDD bursts more efficient. The pluralities of packets A1-A5, B1-B5 corresponding to the two respective E1/T1 data streams are multiplexed onto a shared transmission medium such as the radio link 112 (see FIG. 1), which, in this example, has a data capacity that exceeds the combined data capacity of the two E1/T1 links 104.1, 106.1. For example, the multiplexed packets A1-A5, B1-B5 may be arranged in a sequence in an alternating fashion, e.g., A5, B5, A4, B4, A3, B3, A2, B2, A1, B1, as depicted in FIG. 2a. In this way, the pluralities of packets A1-A5, B1-B5 can be efficiently multiplexed together so that one data stream does not significantly impede the other data stream, thereby avoiding excessive latency for the data. For example, dummy data packets may be stuffed into the data stream between adjacent packets A and B to fill the excess capacity of the radio link 112.

FIG. 2b illustrates the two high priority E1/T1 data streams provided via the respective E1/T1 links 104.1, 106.1, and a single low priority Ethernet data stream provided via the Ethernet link 108.1, for transmission by the radio station 102.1 (see FIG. 1). As shown in FIG. 2b, one of the high priority E1/T1 data streams is segmented into the plurality of packets A1-A5, and the other high priority E1/T1 data stream is segmented into the plurality of packets B1-B5. As in the first example of FIG. 2a, it is assumed that each of the high priority data streams is continuous, and that the size of each of the packets A1-A5, B1-B5 is adjusted to match or be a fraction of the capacity of a TDD burst. The low priority Ethernet data stream includes at least one frame C. The pluralities of packets A1-A5, B1-B5 and the frame C are multiplexed onto a shared transmission medium such as the radio link 112 (see FIG. 1). Whereas, in the example of FIG. 2a, the pluralities of packets A1-A5, B1-B5 can be efficiently multiplexed together so that one data stream does not significantly impede the other data stream, the addition of the low priority Ethernet frame C to the multiplexed high priority E1/T1 packets A1-A5, B1-B5 introduces a significant delay in the transmission of the high priority data. For example, as shown in FIG. 2b, if the packets A1-A5, B1-B5 and the frame C are arranged in a sequence for transmission over the radio link 112 such that the frame C is disposed between the packets A4 and B5, then a significant delay is introduced between the packets A4 and B5 in the sequence, thereby causing increased latency for the high priority E1/T1 data streams.

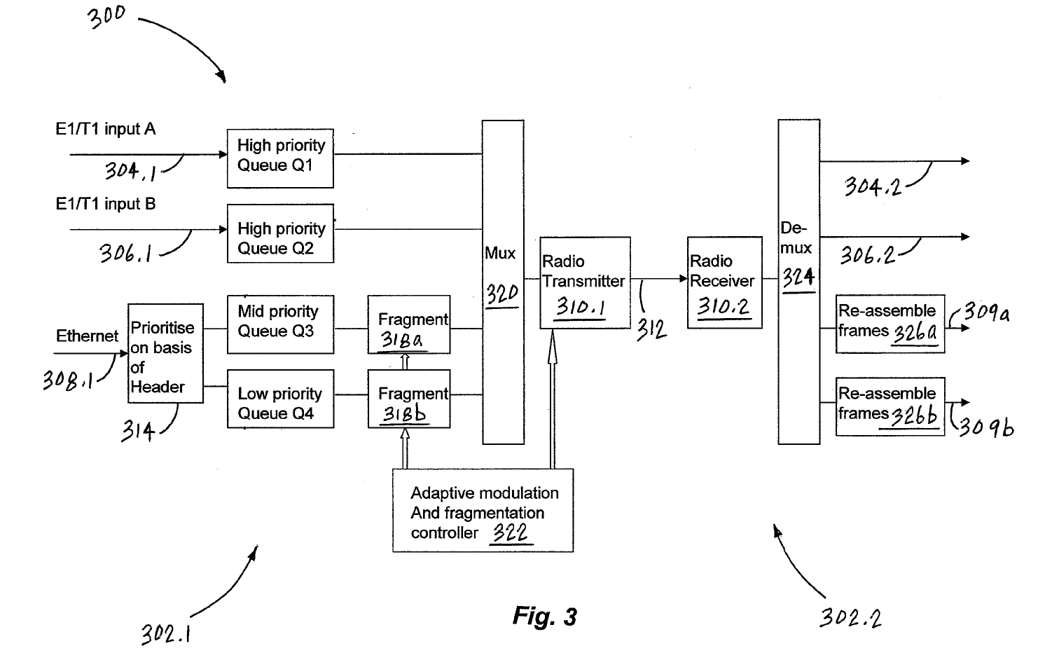

FIG. 3 depicts an illustrative embodiment of a wireless broadband communications system 300 for transmitting multiple streams of high and low priority data over a TDD point-to-point radio link 312, in accordance with the present invention. The wireless broadband communications system 300 may be employed to transmit multiple data streams having different levels of priority over the same radio link, while maintaining the latency for high priority data at an acceptable level. In the illustrated embodiment, the wireless communications system 300 includes two radio stations 302.1-302.2. The radio station 302.1 includes a plurality of queues Q1-Q4 for buffering the multiple data streams based upon their corresponding priority levels. For example, the plurality of queues may include two high priority queues Q1 and Q2, a mid-level priority queue Q3, and a low priority queue Q4. As shown in FIG. 3, the two high priority queues Q1, Q2 are coupled to two high priority E1/T1 communications links 304.1, 306.1, respectively. The E1/T1 link 304.1 provides a first high priority data stream including a plurality of packets A to the high priority queue Q1, and the E1/T1 link 306.1 provides a second high priority data stream including a plurality of packets B to the high priority queue Q2. Because the data structure of an Ethernet data stream may include frames or packets having respective headers that define the type of data service being provided (e.g., mid-level or low priority data), the radio station 302.1 includes a data prioritizor 314 coupled to a low priority Ethernet communications link 308.1. The Ethernet link 308.1 provides mid-level and/or low priority Ethernet frames to the data prioritizor 314, which is configured to determine the type of data service being provided by examining the frame headers, and to buffer the frames in the mid-level and low priority queues Q3, Q4 based upon their respective levels of priority.

The radio station 302.1 also includes two frame fragmentors 318a-318b coupled to the mid-level priority queue Q3 and the low priority queue Q4, respectively; an adaptive modulation and fragmentation controller 322; a data multiplexor 320; and a radio transmitter 310.1 including an antenna (not shown). The adaptive modulation/fragmentation controller 322 enables the frame fragmentors 318a-318b to fragment the frames contained in the mid-level and low priority queues Q3, Q4 based at least in part upon the current data capacity of the radio link 312, which may depend on whether the conditions for wireless signal propagation on the link 312 are favorable or unfavorable.

For example, when propagation conditions are favorable, the frame fragmentors 318a-318b may not operate to fragment the frames contained in the lower priority queues Q3 and Q4, but may instead provide these frames to the data multiplexor 320 in their un-fragmented form. However, when propagation conditions are less favorable due to, e.g., reduced bandwidth availability and/or adverse atmospheric conditions, the adaptive modulation/fragmentation controller 322 may direct the radio transmitter 310.1 to select a modulation format that is less spectrally efficient, reducing the data capacity of the radio link 312. Because the data capacity of the radio link 312 is reduced, the adaptive modulation/fragmentation controller 322 may then direct the frame fragmentors 318a-318b to fragment the frames contained in the mid-level and low priority queues Q3 and Q4, respectively, to form pluralities of fragmented packets of reduced size. The size of the fragmented packets depends on the data rate that can be achieved on the radio link 312, which in turn is dependent on the state of the adaptive modulation/fragmentation controller 322. Because frame fragmentation is generally a bandwidth inefficient process, the frame fragmentors 318a-318b fragment the frames contained in the lower priority queues Q3 and Q4 only when necessary to maintain the latency for the data within acceptable limits. The data multiplexor 320 receives the E1/T1 packets A and B from the high priority queues Q1 and Q2, respectively, and the un-fragmented or fragmented Ethernet frames from the frame fragmentors 318a-318b. The data multiplexor 320 then multiplexes the high priority E1/T1 packets A and B with the mid-level and low priority Ethernet frames for subsequent transmission by the radio transmitter 310.1 over the radio link 312 as wireless signals.

The radio station 302.2 includes a radio receiver 310.2 including an antenna (not shown), a data de-multiplexor 324, and two frame re-assemblers 326a-326b. The radio receiver 310.2 is configured to capture the wireless signals including the multiplexed high priority packets and mid-level and low priority frames transmitted over the radio link 312, and to employ suitable signal processing techniques for decoding and demodulating the signals to recover the user data. The decoded and demodulated data are provided to the de-multiplexor 324, which de-multiplexes the data to recover the high and lower priority data, provides the high priority data stream including the packets A to an E1/T1 communications link 304.2, and provides the high priority data stream including the packets B to an E1/T1 communications link 306.2. The de-multiplexor 324 also provides the mid-level and low priority Ethernet frames to the frame re-assemblers 326a-326b, respectively. If the propagation conditions on the radio link 312 were such that fragmentation of the Ethernet frames by the frame fragmentors 318a-318b was deemed appropriate, then the frame re-assemblers 326a-326b operate to reassemble the fragmented mid-level and low priority frames, and to provide the re-assembled frames to Ethernet communications links 309a-309b, respectively.

It is noted that in a typical TDD system, both a transmitter and a receiver are provided at each end of a radio link, thereby allowing the system to transmit and receive data signals alternately at each end of the link. FIG. 3 depicts the radio station 302.1 transmitting data streams at one end of the radio link 312, and the radio station 302.2 receiving the data streams at the other end of the link 312, for clarity of illustration. It is further noted that the radio link 312 may comprise a point-to-point or point-to-multipoint radio link. Moreover, each of the E1/T1 links 304.1, 306.1 and the Ethernet link 308.1 may operate independently, and may carry data traffic having different levels of priority and different levels of acceptable latency for the data. In addition, each of the links 304.1, 306.1, 308.1 may carry one or more data streams, each of which may have a different priority level and different latency requirements. The multiple data streams carried by the links 304.1, 306.1, 308.1 are multiplexed together by the data multiplexor 320, using any suitable time division multiplexing technique, so that the latency requirements for the data are not violated, regardless of the data rate that can be achieved on the radio link 312 at a given time. To that end, each data stream carried by the links 304.1, 306.1, 308.1 is buffered separately in one of the queues Q1-Q4 based upon the level of priority of the data. Further, each of the data streams buffered in the queues Q1-Q4 may be segmented to form a plurality of frames or packets. The frames in the lower priority queues Q3-Q4 may then be fragmented by the frame fragmentors 318a-318b, depending on the current data capacity of the radio link, to form a plurality of fragmented packets of reduced size. Finally, the high priority packets and the un-fragmented or fragmented lower priority packets are time division multiplexed by the data multiplexor 320 for subsequent transmission in a sequence by the radio transmitter 310.1 over the radio link 312, while maintaining the latency for the high priority data at an acceptable level.

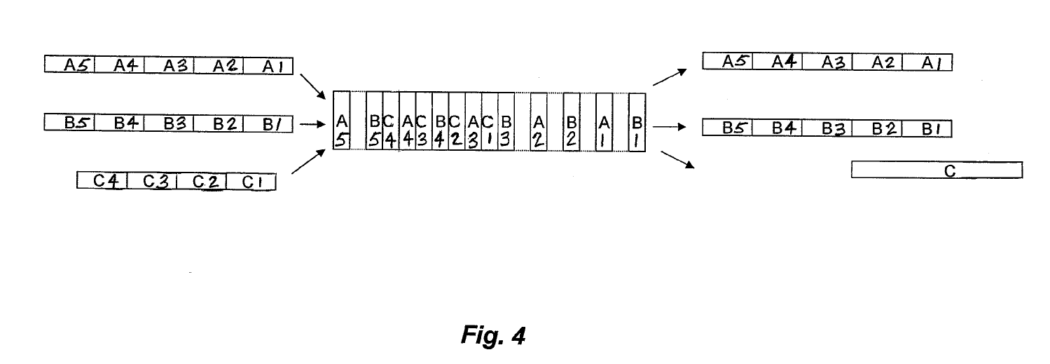

The operation of the presently disclosed wireless broadband communications system 300 will be better understood with reference to the following illustrative example and FIGS. 3-5. FIG. 4 illustrates two high priority E1/T1 data streams provided via the respective E1/T1 links 304.1, 306.1, and a single low priority Ethernet data stream provided via the Ethernet link 308.1, for transmission by the radio station 302.1 (see FIG. 3). As shown in FIG. 4, one of the high priority E1/T1 data streams is segmented into a plurality of packets A1-A5, and the other high priority E1/T1 data stream is segmented into a plurality of packets B1-B5. Further, the low priority Ethernet data stream includes at least one frame C. In this example, it is assumed that each of the high priority data streams is continuous. In addition, it is assumed that the bandwidth availability and/or the atmospheric conditions are such that the adaptive modulation/fragmentation controller 322 directs the radio transmitter 310.1 to select a modulation format that is less spectrally efficient, reducing the data capacity of the radio link 312.

Because the data capacity of the radio link 312 is reduced due to reduced bandwidth availability and/or adverse atmospheric conditions, the adaptive modulation/fragmentation controller 322 directs the frame fragmentors 318a-318b to fragment the Ethernet frame C to form a plurality of fragmented packets C1-C4 of reduced size. The data multiplexor 320 multiplexes the pluralities of high priority data packets A1-A5, B1-B5 and the low priority fragmented data packets C1-C4 by arranging the packets in a sequence, e.g., A5, B5, C4, A4, C3, B4, C2, A3, C1, B3, A2, B2, A1, B1, as depicted in FIG. 4, or any other suitable packet sequence. In this example, the size of the fragmented packets C1-C4 corresponds to the size of timeslots occurring between the high priority packets A1-A5, B1-B5. Specifically, the size of the fragmented packets C1, C2, C3, and C4 corresponds to the size of the timeslots between the packets A3 and B3, B4 and A3, A4 and B4, and B5 and A4, respectively, in the packet sequence.

In addition, because the packet sequence is to be transmitted over a TDD point-to-point radio link, the size of the fragmented packets C1-C4 is adjusted to match or be a fraction of the capacity of the TDD transmission bursts, thereby making the process of assembling the TDD bursts more efficient. It is noted that the capacity of the TDD transmission bursts is dependent on the state of the adaptive modulation/fragmentation controller 322. For example, by adjusting the size of the fragmented packets C1-C4 to match the capacity of the TDD transmission bursts, alternate TDD bursts can be made to carry alternate data streams. Further, by adjusting the size of the fragmented packets C1-C4 to be a fraction of the capacity of the TDD transmission bursts, each TDD burst can be made to carry packets from a plurality of data streams.

The radio transmitter 310.1 transmits the packet sequence over the radio link 312 as a wireless signal under control of the adaptive modulation/fragmentation controller 322. The radio receiver 310.2 receives the transmitted signal, demodulates and decodes the received signal as appropriate, and provides the demodulated and decoded signal to the data de-multiplexor 324, which de-multiplexes the packet sequence to recover the two high priority E1/T1 data streams including the pluralities of packets A1-A5, B1-B5, and the fragmented packets C1-C4. In addition, the frame re-assemblers 326a-326b reassemble the low priority Ethernet data stream from the fragmented packets C1-C4 to recover the original data format of the Ethernet frame C. Although multiplexing the two high priority data streams with the fragmented, low priority packets C1-C4 for transmission over the radio link 312 may introduce a delay in the transmission of the low priority Ethernet frame C, reduced levels of delay or latency are introduced for the delay-critical, high priority data represented by the packets A1-A5, B1-B5.

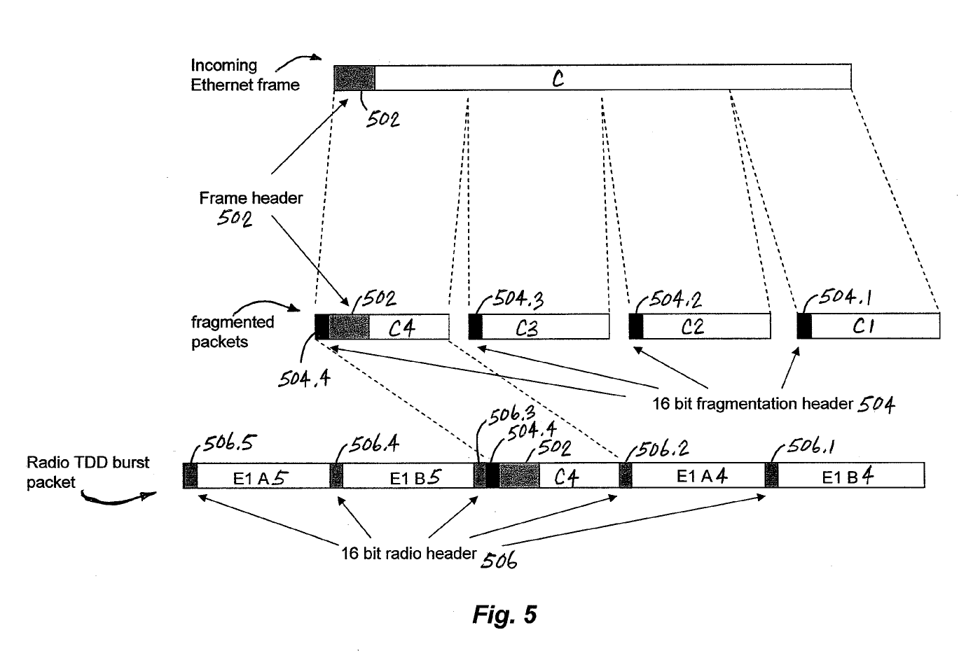

FIG. 5 depicts illustrative data structures of the Ethernet frame C, the fragmented packets C1-C4 corresponding to the frame C, and a TDD transmission burst including portions of the high priority packets A1-A5, B1-B5 and the fragmented, low priority packets C1-C4. As shown in FIG. 5, the Ethernet frame C includes a frame header 502. It is noted that the Ethernet frame C may have a length of up to 1500 bytes plus the header 502 for typical Ethernet applications, up to about 9000 bytes for proprietary “jumbo” packets, or any other suitable length. If the propagation conditions on the radio link are such that fragmentation of the Ethernet frame C is deemed appropriate, then the frame C may be divided into four fragments, or any other suitable number of fragments, as represented by the fragmented packets C1-C4. Each of the fragmented packets C1, C2, C3, C4 includes a fragmentation header 504.1, 504.2, 504.3, 504.4, respectively, which identifies the fragmented packet C1-C4 associated therewith. In the illustrative data structure of FIG. 5, the fragmented packet C4 also includes the frame header 502. The fragmentation headers 504.1-504.4 are removed when the Ethernet frame C is re-assembled at the receiver. The fragmented packets C1-C4 may be transmitted over the radio link in one or more TDD bursts with other packets from other data streams. As shown in FIG. 5, one of the TDD bursts may include the packets B4, A4, B5, A5 from the high priority E1/T1 data streams, and the fragmented packet C4 from the lower priority Ethernet frame C, arranged in a sequence, e.g., B4, A4, C4, B5, A5, or any other suitable sequence. Each of the packets B4, A4, C4, B5, A5 in the packet sequence includes a radio header 506.1, 506.2, 506.3, 506.4, 506.5, respectively, which identifies the packet associated therewith. The radio headers 506.1-506.5 are removed when the high priority data streams and the lower priority Ethernet frame are recovered at the receiver.

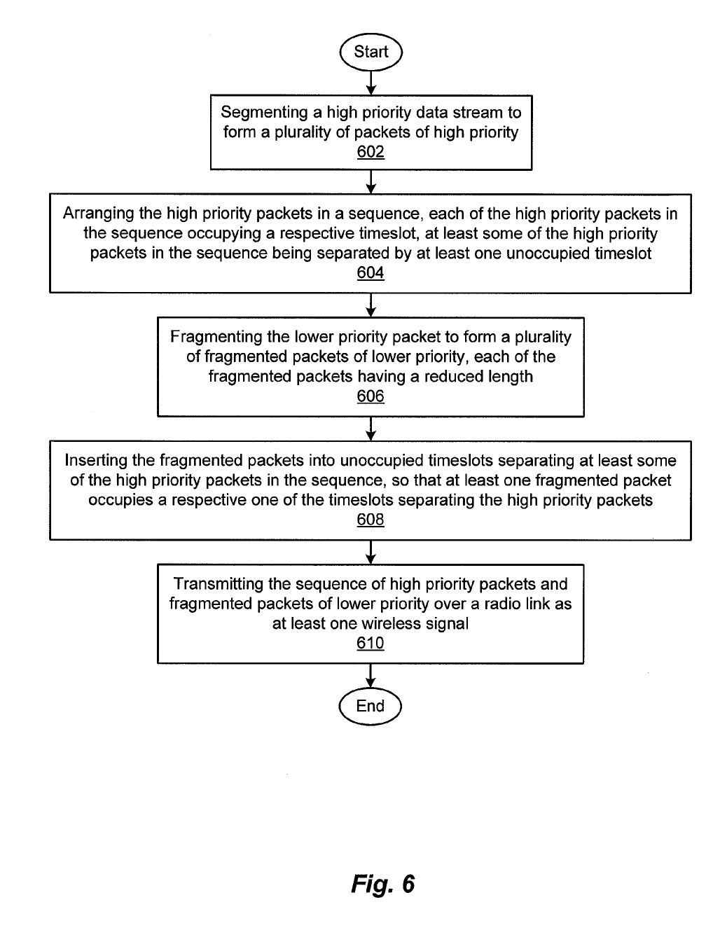

A method of operating the wireless broadband communications system 300 is described below with reference to FIGS. 3 and 6. The wireless communications system 300 employs time division multiplexing to transmit a plurality of data streams of different priorities over the same radio link, while reducing latency associated with at least one high priority data stream transmitted over the link. As depicted in step 602, the high priority data stream is segmented to form a plurality of packets of high priority. It is noted that the plurality of data streams includes at least one lower priority data stream, which includes at least one packet of lower priority. Further, each of the high priority and lower priority packets has a corresponding length. Next, the high priority packets are arranged in a sequence, as depicted in step 604. The positions of the high priority packets in the sequence are defined by a plurality of timeslots. Moreover, each of the high priority packets in the sequence occupies a respective timeslot. In addition, at least some of the high priority packets in the sequence are separated by at least one unoccupied timeslot. The lower priority packet is then fragmented to form a plurality of fragmented packets of lower priority, as depicted in step 606. Each of the plurality of fragmented packets has a reduced length. Next, the fragmented packets of lower priority are inserted into unoccupied timeslots separating at least some of the high priority packets in the sequence, so that at least one fragmented packet occupies a respective one of the timeslots separating the high priority packets, as depicted in step 608. Finally, the sequence of high priority packets and fragmented packets of lower priority is transmitted over the radio link as at least one wireless signal, as depicted in step 610.

It should be appreciated that the functions necessary to implement the present invention may be embodied in whole or in part using hardware, software, firmware, or some combination thereof using micro-controllers, microprocessors, digital signal processors, programmable logic arrays, or any other suitable types of hardware, software, and/or firmware.

It will further be appreciated by those of ordinary skill in the art that modifications to and variations of the above-described system and method of reducing latency by adaptive packet fragmentation may be made without departing from the inventive concepts disclosed herein. Accordingly, the invention should not be viewed as limited except as by the scope and spirit of the appended claims.

What is claimed is:

1. In a wireless communications system employing time division multiplexing to transmit a plurality of data streams of different priorities over the same radio link, a method of reducing latency associated with at least one high priority data stream transmitted over the radio link, comprising:
segmenting the at least one high priority data stream to form a plurality of packets of high priority,
wherein the plurality of data streams includes at least one lower priority data stream, the at least one lower priority data stream including at least one packet of lower priority, each of the high priority and lower priority packets having a corresponding length;
arranging the high priority packets in a sequence,
wherein positions of the high priority packets in the sequence are defined by a plurality of timeslots, each of the high priority packets in the sequence occupying a respective timeslot, at least some of the high priority packets in the sequence being separated by at least one unoccupied timeslot;
fragmenting the at least one lower priority packet to form a plurality of fragmented packets of lower priority, each of the plurality of fragmented packets having a reduced length;
inserting the fragmented packets of lower priority into unoccupied timeslots separating at least some of the high priority packets in the sequence; and
transmitting the sequence of high priority packets and fragmented packets of lower priority over the radio link as at least one wireless signal.

2. The method of claim 1 comprising buffering the at least one high priority data stream and the at least one lower priority data stream in a plurality of queues according to priority.

3. The method of claim 2 wherein the inserting step comprises inserting the fragmented packets of lower priority into unoccupied timeslots separating at least some of the high priority packets in the sequence when each of the plurality of queues for buffering data corresponding to the at least one high priority data stream is empty.

4. The method of claim 1 comprising determining a level of priority corresponding to each of the plurality of data streams by identifying a physical source of the respective data stream.

5. The method of claim 1 comprising determining a level of priority corresponding to each of the plurality of data streams by examining information contained in at least one packet header.

6. The method of claim 1 wherein the segmenting step comprises adding a packet header to each of the plurality of packets of high priority.

7. The method of claim 1 wherein the fragmenting step comprises adding a packet header to each of the plurality of fragmented packets of lower priority.

8. The method of claim 1 wherein the transmitting step comprises transmitting the sequence of high priority packets and fragmented packets of lower priority over the radio link in at least one time division duplex (TDD) burst.

9. The method of claim 8 wherein the fragmenting step comprises fragmenting the at least one lower priority packet so that the sequence of high priority packets and fragmented packets of reduced length matches a capacity of a TDD burst.

10. The method of claim 8 wherein the fragmenting step comprises fragmenting the at least one lower priority packet so that the sequence of high priority packets and fragmented packets of reduced length corresponds to a fraction of a capacity of a TDD burst.

11. The method of claim 1 comprising:
receiving the sequence of high priority packets and fragmented packets of lower priority transmitted over the radio link as at least one wireless signal; and
reassembling the at least one high priority data stream and the at least one lower priority data stream from the high priority packets and the fragmented packets of lower priority.

12. The method of claim 11 wherein the segmenting step comprises adding a packet header to each of the plurality of packets of high priority; wherein the fragmenting step comprises adding a packet header to each of the plurality of fragmented packets of lower priority; and wherein the reassembling step comprises removing the packet header from each of the high priority packets and the fragmented packets of lower priority.

13. The method of claim 1 comprising adaptively modulating the at least one wireless signal according to a specified state of adaptive modulation prior to transmission, wherein the state of adaptive modulation corresponds to a current data capacity of the radio link.

14. The method of claim 13 wherein the fragmenting step comprises fragmenting the at least one lower priority packet to form a plurality of fragmented packets having a reduced length depending on the state of adaptive modulation.

15. A wireless communications system employing time division multiplexing to transmit a plurality of data streams of different priorities over the same radio link, comprising:
a first component operative to segment at least one high priority data stream to form a plurality of packets of high priority,
wherein the plurality of data streams comprises at least one lower priority data stream, the at least one lower priority data stream comprising at least one packet of lower priority, each of the high priority and lower priority packets having a corresponding length;
a second component operative to arrange the high priority packets in a sequence,
wherein positions of the high priority packets in the sequence are defined by a plurality of timeslots, each of the high priority packets in the sequence occupying a respective timeslot, at least some of the high priority packets in the sequence being separated by at least one unoccupied timeslot;
a third component operative to fragment the at least one lower priority packet to form a plurality of fragmented packets of lower priority, each of the plurality of fragmented packets having a reduced length;
a fourth component operative to insert the fragmented packets of lower priority into unoccupied timeslots separating at least some of the high priority packets in the sequence; and
a radio transmitter configured to transmit the sequence of high priority packets and fragmented packets of lower priority over the radio link as at least one wireless signal.

16. The system of claim 15 comprising a plurality of queues configured to buffer the at least one high priority data stream and the at least one lower priority data stream according to priority.

17. The system of claim 16 wherein the fourth component is operative to insert the fragmented packets of lower priority into unoccupied timeslots separating at least some of the high priority packets in the sequence when each of the plurality of queues for buffering data corresponding to the at least one high priority data stream is empty.

18. The system of claim 15 comprising a fifth component operative to determine a level of priority corresponding to each of the plurality of data streams by identifying a physical source of the respective data stream.

19. The system of claim 15 comprising a fifth component operative to determine a level of priority corresponding to each of the plurality of data streams by examining information contained in at least one packet header.

20. The system of claim 15 wherein the first component is operative to add a packet header to each of the plurality of packets of high priority.

21. The system of claim 15 wherein the third component is operative to add a packet header to each of the plurality of fragmented packets of lower priority.

22. The system of claim 15 wherein the radio transmitter is configured to transmit the sequence of high priority packets and fragmented packets of lower priority over the radio link in at least one time division duplex (TDD) burst.

23. The system of claim 22 wherein the third component is operative to fragment the at least one lower priority packet so that the sequence of high priority packets and fragmented packets of reduced length matches a capacity of a TDD burst.

24. The system of claim 22 wherein the third component is operative to fragment the at least one lower priority packet so that the sequence of high priority packets and fragmented packets of reduced length corresponds to a fraction of a capacity of a TDD burst.

25. The system of claim 15 comprising a radio receiver configured to receive the sequence of high priority packets and fragmented packets of lower priority transmitted over the radio link as at least one wireless signal, and a fifth component operative to reassemble the at least one high priority data stream and the at least one lower priority data stream from the high priority packets and the fragmented packets of lower priority upon reception.

26. The system of claim 25 wherein the first component is operative to add a packet header to each of the plurality of packets of high priority, wherein the third component is operative to add a packet header to each of the plurality of fragmented packets of lower priority, and wherein the fifth component is operative to remove the packet header from each of the high priority packets and the fragmented packets of lower priority.

27. The system of claim 15 wherein the radio transmitter is configured to adaptively modulate the at least one wireless signal according to a specified state of adaptive modulation prior to transmission, wherein the state of adaptive modulation corresponds to a current data capacity of the radio link.

28. The system of claim 27 wherein the third component is operative to fragment the at least one lower priority packet to form a plurality of fragmented packets having a reduced length depending on the state of adaptive modulation.
